(19) United States
(12) Patent Application Publication
(10) Pub. No.: US 2007/0159517 A1
(43) Pub. Date: Jul. 12, 2007

(54) METHOD OF ERASING IMAGE, IMAGE ERASING APPARATUS, AND METHOD OF RECYCLING RECORDING MEDIUM

(75) Inventors: Yuichi Hashimoto, Tokyo (JP); Waka Hasegawa, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/689,400

(22) Filed: Mar. 21, 2007

Related U.S. Application Data
(63) Continuation of application No. PCT/JP06/20045, filed on Sep. 29, 2006.

(30) Foreign Application Priority Data
Sep. 30, 2005 (JP) 2005-287523

(51) Int. Cl. G01D 11/00

(52) U.S. Cl. 347/100

(57) ABSTRACT

A method of erasing an image for erasing an image formed by applying ink containing a dye to a recording medium. The image is exposed to an oxidizing gas generated by dielectric barrier discharge. An apparatus for performing the method and a method of recycling the recording medium are also provided.

This application is a continuation of International Application No. PCT/JP2006/320045 filed on Sep. 29, 2006, which claims the benefit of Japanese Patent Application No. 2005-287523 filed on Sep. 30, 2005.

### BACKGROUND OF THE INVENTION

1. Field of the Invention

The present invention relates to a method of erasing an image formed on a recording medium, an image erasing apparatus, and a method of recycling a recording medium.

2. Description of the Related Art

Along with the spread of computers, printers, copying machines, facsimiles etc., requirement for output on paper is increasing more and more. No other media have ever become comparable to paper in visibility and portability, and although realizing electronic information society or paperless society has shown progress, the demand for paper is still increasing.

On the other hand, in order to effectively utilize limited resources, technical development for recycling and reuse of paper is becoming increasingly important. In a prior paper recycling method, a recovered paper is repulped with water, then subjected to floating removal of an ink portion by a deinking process, further bleached and used as “recycled paper”. However the method has drawbacks that the paper strength is lowered and that a process cost is higher in comparison with a case of manufacturing new paper. Consequently, there is desired a method capable of reusing or recycling paper without repulping and deinking processes.

Based on the background, investigations are being made for a method of printing paper with an image forming material including an erasable dye composition capable of changing a color-forming compound in a colored state to an erased state. Reported examples of the image forming material include a material involving the utilization of a reversible change in transparency of a recording layer based on the control of heat energy to be applied (see Japanese Patent Application Laid-Open No. S63-39377) and a material involving the utilization of an intermolecular interaction between a color coupler having electron-donating property and a developer having electron-accepting property (see Japanese Patent Application Laid-Open No. 2001-105741). There have been also reported an ink containing a dye which is decolored by irradiation with an electron beam (see Japanese Patent Application Laid-Open No. H11-116864) and an ink containing an additive having an action of decoloring a colorant by irradiation with light (see Japanese Patent Application Laid-Open No. 2001-49157). Further, there have been reported an ink-jet ink using a Monascus dye so that the ink can be decolored by irradiation with light, and a recording method using the ink (see WO 02/088265). In addition, a method of decomposing and erasing an image on plain paper by using an activated gas has been proposed (see Japanese Patent Application Laid-Open No. H07-253736).

### SUMMARY OF THE INVENTION

However the methods described in Japanese Patent Application Laid-Open No. S63-39377 and Japanese Patent Application Laid-Open No. 2001-105741 are impractical since the recording medium, writing-erasing apparatus etc. are expensive in the initial cost and in the running cost. Also, the method described in Japanese Patent Application Laid-Open No. H11-116864, employing electron beam irradiation, may cause the deterioration of a base material or generation of a secondary X-ray, even though slightly. Also in the ink described in Japanese Patent Application Laid-Open No. 2001-49157, the additive to be employed is more specifically a dye-based sensitizer and is employed in a large amount of 1/10 to 10/10 in weight ratio with respect to the coloring material, thus resulting a high cost of the ink. Also, there is a demand for a method capable of erasing an image easier and more quickly compared to the methods described in WO 02/088265 pamphlet and Japanese Patent Application Laid-Open No. H07-253736.

Therefore, an object of the present invention is to provide a method with which an image (including a letter) formed on a recording medium typified by paper is easily and quickly erased without any reduction in mechanical strength of the recording medium so that the used recording medium can be recycled at a low cost and the reuse of resources can be achieved.

Another object of the present invention is to provide an apparatus for performing the method.

In view of the above objects, the inventors of the present invention have made extensive studies while paying attention to a dielectric barrier discharge technique employed in the removal and decomposition of an exhaust gas or of an organic contaminant. When dielectric barrier discharge is employed in the removal and decomposition of an exhaust gas or of an organic contaminant, an apparatus for the discharge is actuated by applying an alternating voltage having a high frequency ranging from several tens of kilohertz to a microwave frequency, so the amount of ozone to be produced is several hundreds of parts per million or more, which is an extremely high concentration. Accordingly, one has shouldered a burden upon treatment of ozone, and has been unable to erase an image efficiently.

The inventors of the present invention have found that the oxidation reaction of a dye molecule can be appropriately advanced by exposing an image (including a letter, the same holds true for the following) formed on a recording medium to an oxidizing gas generated by specific discharge, whereby the image can be erased efficiently without any adverse effect on an environment. Moreover, the inventors of the present invention have found that an image can be erased easily and quickly at a low cost by using a specific alternating voltage. Further, when the surface of a recording medium has a porous inorganic pigment, an image can be erased with improved efficiency. In addition, the inventors of the present invention have found the following: when an image is formed on a recording medium having a specific surface, the ionization potential of a dye in the image can be made lower than that of the dye in a solid state, and the above effects can be exerted in an additionally excellent manner as a result of the lowering. The inventors of the present invention have found that the above effects become additionally significant when a dye powder before being turned into ink has a specific ionization potential, and has a specific ionization potential in relation to the ionization potential of the dye in a solid state after the formation of an image. The inventors of the present invention have completed the present invention on the basis of such findings.

The present invention provides a method of erasing an image for erasing an image formed by applying ink containing a dye to a recording medium, including exposing the image to an oxidizing gas generated by dielectric barrier discharge.

Further, the present invention provides an image erasing apparatus for erasing an image formed by applying ink containing a dye to a recording medium, including means for exposing the image to an oxidizing gas generated by dielectric barrier discharge; and supporting means for placing the recording medium so that the recording medium is exposable to the oxidizing gas.

Still further, the present invention provides a method of recycling a recording image including the step of erasing an image by the above-mentioned method of erasing an image.

According to the present invention, an image formed on a recording medium typified by paper can be erased easily and quickly at a low cost without any reduction in mechanical strength of the recording medium. In addition, the used recording medium can be recycled at a low cost, the size of the apparatus can be reduced, and the reuse of resources can be achieved.

Further features of the present invention will become apparent from the following description of exemplary embodiments with reference to the attached drawings.

### BRIEF DESCRIPTION OF THE DRAWINGS

FIG. 1 is a schematic lateral view showing an example of an image erasing apparatus of the present invention.

FIG. 2 is a schematic lateral view showing another example of the image erasing apparatus of the present invention.

FIG. 3 is a schematic lateral view showing still another example of the image erasing apparatus of the present invention.

FIG. 4 is a schematic lateral view showing still another example of the image erasing apparatus of the present invention.

FIG. 5 is a schematic view showing an example of a power supply for use in the image erasing apparatus of the present invention.

FIG. 6 is a schematic view showing an example of an aerial gap for use in the image erasing apparatus of the present invention.

FIG. 7 is a schematic view showing an example of the aerial gap for use in the image erasing apparatus of the present invention.

### DESCRIPTION OF THE EMBODIMENTS

A method of erasing an image of the present invention is a method of erasing an image for erasing an image formed by applying ink containing a dye to a recording medium, and is characterized by including exposing the image to an oxidizing gas generated by dielectric barrier discharge.

The term “erasing of an image” as used herein refers to a state where the optical density of an image formed on a recording medium is reduced by an erasing treatment to such an extent that the resultant can be recycled as a recording medium. Such state includes not only the case where the image formed on the recording medium cannot be visually recognized at all (hereinafter abbreviated as “decoloring”) but also the case where an optical density is reduced to 80% or less of the optical density of an initial image formed on the recording medium (hereinafter abbreviated as “color reduction”). The color reduction represented in terms of a residual optical density rate corresponds to the case where an optical reflectance is reduced to 20% or less of an initial optical reflectance at the maximum absorption wavelength of a colored portion.

(Recording Medium)

A recording medium to be used in the present invention is not limited as long as an image can be formed by applying ink containing a dye to the recording medium. Examples of the recording medium include paper, a film, a photographic paper, a seal, a label, a compact disk, a metal, glass, various plastic products, a form for a delivery service, and a composite material thereof. In the case of paper, there can be employed any recyclable paper, and an acidic paper, a neutral paper, or an alkaline paper may be employed. Examples of a method for producing the paper include a method in which: a base paper is principally constituted of a chemical pulp represented by LBKP or NBKP, and a filler; and papermaking is executed by an ordinary method utilizing an internal sizing agent or a papermaking additive, if necessary. Examples of a pulp material to be used include a combination of a mechanical pulp and a recycled pulp, and a pulp material principally including those pulps. Examples of a filler include calcium carbonate, kaolin, talc, and titanium dioxide. The thus-obtain ed paper may further contain a hydrophilic binder, a matting agent, a hardening agent, a surfactant, a polymer latex, or a polymer mordanting agent, or be applied with each of those agents. The paper preferably has a basis weight in a range of 40 to 700 g/m².

The recording medium to be used in the present invention preferably has a porous inorganic pigment in its surface, and a layer containing an inorganic pigment is preferably provided on the recording medium. The particle shape of the porous inorganic pigment may be each of a spherical shape and a crushed shape. Further, the porous inorganic pigment is preferably of a particulate shape having a pore volume of 0.2 cc/g or more or a dispersed particle size of 0.5 μm or less, or of a particulate shape having a pore volume of 0.2 cc/g or more and a dispersed particle size of 0.5 μm or less. The porous inorganic pigment preferably has a pore volume of 0.2 to 2.0 cc/g and a dispersed particle size of 0.01 to 0.5 μm. When the porous inorganic pigment has such pore volume and dispersed particle size, the ionization potential of a dye to be described later in an image formed by using the dye can be reduced. To be specific, the ionization potential can be made lower than the ionization potential of the dye in a solid state by 0.1 eV or more, whereby an excellent erasing effect on an image can be obtained. The pore volume of the porous inorganic pigment can be measured with a mercury porosimeter according to a method of mercury penetration. In general, the recording medium and the inorganic pigment are different from each other in pore size, so the pore volume of only the porous inorganic pigment can be calculated by detecting the distribution of a pore volume with respect to a pore size with a mercury porosimeter. The dispersed particle size can be measured by observation with a scanning electron microscope.

Specific examples of the porous inorganic pigment include alumina, silica, silica-alumina, colloidal silica, zeolite, clay, kaolin, talc, calcium carbonate, barium sulfate, aluminum hydroxide, titanium dioxide, zinc oxide, satin white, diatomaceous clay, acidic white clay, and a composite material of alumina and silica.

An example of a method of producing a recording medium using the porous inorganic pigment is a method involving: preparing an aqueous coating liquid by adding an aqueous binder to the porous inorganic pigment; and coating a recording medium typified by paper (base paper) with the resultant aqueous coating liquid. Examples of the aqueous binder include, but not limited to, the following.

Examples of the aqueous binder include water-soluble polymer compounds such as polyvinyl alcohol, casein, a styrene-butadiene rubber, starch, polyacrylamide, polyvinyl pyrrolidone, polyvinyl methyl ether, and polyethylene oxide.

A mass ratio of the above porous inorganic pigment to the above aqueous binder (porous inorganic pigment/aqueous binder) is in the range of 0.1 to 100, or, if limited, is preferably in the range of 1 to 20. A mass ratio of the porous inorganic pigment to the aqueous binder (porous inorganic pigment/aqueous binder) of 100 or less can suppress the coming of the porous inorganic pigment off the recording medium, so called, powder falling. A mass ratio of the porous inorganic pigment to the aqueous binder (porous inorganic pigment/aqueous binder) of 0.1 or more can provide excellent color-reducing property or excellent decoloring property for an ink-jet image formed on the recording medium. The aqueous coating liquid may be blended, if necessary, with any of a pigment dispersant, a water retention agent, a thickener, a deforming agent, a releasing agent, a colorant, a water resistant additive, a humectant, a fluorescence dye, and a UV-ray absorber.

Examples of a method of coating the recording medium with the above aqueous coating liquid include the following methods. That is, the examples include a roller coating, a blade coating, an air knife coating, a gate roll coating, a bar coating, a spray coating, a gravure coating, a curtain coating, or a comma coating.

A preferable amount of the above aqueous coating liquid with which the recording medium is coated is, for example, in the range of 0.1 to 50 g/m² in terms of a solid content. An amount of the aqueous coating liquid with which the recording medium is coated of 0.1 g/m² or more can quickly reduce the color of, or decolor, an ink-jet image in the recording medium. On the other hand, an amount of the aqueous coating liquid with which the recording medium is coated of 50 g/m² or less can avoid the wasteful consumption of the aqueous coating liquid.

After the recording medium has been coated with the above aqueous coating liquid, the above aqueous coating liquid in a wet state may be subjected to a treatment involving the application of an aqueous solution containing the nitrate, sulfate, formate, or acetate of zinc, calcium, barium, magnesium, or aluminum for solidifying the aqueous binder. The coating film of the aqueous coating liquid on the recording medium is dried by using a hot-air drying furnace or a heat drum, whereby the recording medium the surface of which has been treated can be obtained. When the coating film of the aqueous coating liquid on the recording medium is dried by using a heat drum, a coating layer can be obtained by crimping and drying the heated coating film. In addition, after the drying, the recording medium is subjected to a calender treatment, whereby a strong coating film that shows neither film peeling nor powder falling can be obtained.

(Ink)

A mechanism to be employed in the present invention via which an image is erased is considered to be as follows: ink fixed on a recording medium is exposed to an oxidizing gas, whereby the cleavage reaction of a chemical bond of a dye progresses, and hence the ink is decolored. Such decoloring of the dye easily progresses by exposure to the oxidizing gas as long as a dye in a solid state before the preparation of the ink has an ionization potential of 6.0 eV or less. A necessary condition for the prevention of oxidation and the suppression of deterioration by light in the air is a state where the dye in a solid state before the preparation of the ink has an ionization potential of 4.2 eV or more.

Further, it is necessary for the ionization potential of the dye in the image formed on the recording medium to be lower than that of the dye in a solid state before the preparation of the ink by 0.1 eV or more, or, if additionally limited, 0.15 to 0.7 eV. Such relationship between the ionization potentials of the dye causes the decoloring to occur with improved ease and improved quickness. Setting the ionization potential of the dye in the image formed on the recording medium within the range requires the porous inorganic pigment possessed by the recording medium to have a pore volume of 0.2 cc/g or more or a dispersed particle size of 0.5 μm or less.

Although details about the mechanism are unclear, the mechanism can be considered to be as described below.

It is generally known that a value for the ionization potential of a dye is closely related to the agglomerated state of the molecules of the dye (see T. Ma, K. Inoue, H. Noma, K. Yao, E. Abe, “Ionization potential studies of organic dye adsorbed onto TiO₂ electrode”, Journal of Materials Science Letters, 2002, Vol. 21, p. 1013-1014).

On the other hand, when ink containing a dye is applied to a recording medium containing a porous inorganic pigment, the molecules of the dye are individually adsorbed to the pores of the surface of the porous inorganic pigment, whereby the aggregation of the molecules of the dye is suppressed. As a result, there may be a tendency of the ionization potential of the dye in an image to be lower than that of a solid (aggregated state). In contrast, when the pore volume or dispersed particle size of the porous inorganic pigment is incompatible with the molecules of the dye in the ink, the ionization potential of the dye in the image hardly reduces. Such value for the ionization potential of the dye can be determined from a point of contact between a current emitted by a photoelectron in accordance with Fowler's law and photon energy by using an aerial photoelectron spectrometer (manufactured by RIKEN KEIKI Co., Ltd., AC-1).

Ink to be used in the present invention is not limited as long as the ink contains a dye that can form an image on the above recording medium. The image may be one formed on the recording medium by printing using a printer, copying machine, or printing machine according to an ink-jet system, or may be one formed by using a writing instrument typified by a pen; the image is desirably one according to an ink-jet recording system. An example of such ink is one prepared by dissolving, dispersing, or dissolving and dispersing a dye in an organic solvent or water.

(Dye)

Any of a natural dye, a synthetic dye, and a dye that develops a color owing to an action of a developer may be incorporated into the above ink; a dye having a polyene structure is desirable. Examples of a dye having a polyene structure include the conjugated polyenes of carotenoid typified by an annatto dye and a gardenia yellow dye. The dye to be incorporated into the ink used in the present invention may contain any of a natural dye and a synthetic dye; one containing a natural dye is desirable in terms of safety for a human body. Examples of the above natural dye include: microbial dyes produced by microorganisms; and extracted dyes extracted from animals/plants. The microbial dyes are produced by the culture of microorganisms, and are easier in the management of production than the extracted dyes, and further can be produced more stably and in larger amounts.

The microbial dyes can be typically obtained through extraction from the culture solution of microorganisms that produce the dyes by using strains that produce the microbial dyes with the aid of a non-limitative, known culture method. The culture solution can be concentrated as it is without extraction or purification to be used as a dye to be incorporated into ink as long as the resultant can retain ink properties. Specific examples of such microbial dyes include the following: a Monascus dye, biolacein, melanin, carotenoid, chlorophyll, phycobilin, flavin, phenazine, prodigiosin, an indigo-based dye, benzoquinone, naphthoquinone, anthraquinone, and any known dye (see Pigment microbiology, by P. Z. Margalith, Chapman & Hall, London (1992)). Of those microbial dyes, a Monascus dye, biolacein, and an indigo-based dye are each excellent in decoloring property with an oxidizing gas to be described later. Of those, a Monascus dye can be exemplified.

Such Monascus dye is a dye produced by a filamentous bacterium belonging to the genus Monascus (Monascaceae fungus). The dye has been used as a colorant for red liquor or meat in China and Taiwan since olden times, and its safety has been confirmed. A Monascus dye is generally a composition composed of compounds having similar structures and different substituents such as monascorubrin having an orange-based color, ankaflavin having a yellow-based color, monascin having a yellow-based color, and monascorubramin, rubropunctatin, and rubropunctamine each having a red-based color (see J. Ferment. Technol., Vol. 51, p. 407 (1973)). Each of those compounds is insoluble in water; provided that each of monascorubrin and rubropunctatin is known to react with a water-soluble amino compound, water-soluble protein, peptide, or amino acid in a culture solution to form a water-soluble composite, thereby resulting in a red-based, water-soluble, Monascus dye (see Journal of Industrial Microbiology, Vol. 16, pp. 163-170 (1996)).

A Monascaceae strain that produces a Monascus dye has only to be a filamentous bacterium belonging to the genus Monascus. Examples of the filamentous bacterium belonging to the genus Monascus include Monascus purpureus (catalog number NBRC 4478 of the Incorporated Administrative Agency National Institute of Technology and Evaluation, Biological Resource Center (NBRC)), Monascus pilosus (catalog number NBRC 4480 of the center), and Monascus ruber (catalog number NBRC 9203 of the center). The examples further include the variants and mutants of the foregoing.

Each of a solid culture method involving the use of a solid medium and a liquid culture method involving the use of a liquid medium can be employed as a method of culturing a Monascaceae strain for producing a Monascus dye to be incorporated into the ink in the method of erasing an image of the present invention. A powdery Monascus dye is obtained by the solid culture method while a liquid Monascus dye or an extract of the dye with an organic solvent is obtained by the liquid culture method. A medium may be a known one containing a carbon source, a nitrogen source, the inorganic salts, and a trace amount of a nutrient. There can be utilized a medium which contains: any one of the saccharides such as glucose and sucrose, or the hydrolysate of acetic acid or of starch as a carbon source; peptone and a yeast extract or a malt extract as a nitrogen source and a trace amount of a nutrient; and a sulfate and a phosphate as the inorganic salts.

A specific example of a method of culturing a Monascaceae strain is a method involving: inoculating Monascaceae fungi in such medium; and aerobically culturing the resultant at a temperature of 20 to 40° C. for 2 to 14 days. When aeration-agitation culture is performed, there is no need to control pH; provided that, when culture is performed under acidic conditions, a reaction between each of monascorubrin and rubropunctatin described above and a water-soluble amino compound is inhibited, whereby a dye containing large amounts of monascorubrin and rubropunctatin can be prepared (see Journal of Industrial Microbiology, Vol. 16, pp. 163-170 (1996)).

An example of a method of extracting a Monascus dye is a method involving extraction from a culture solution or a bacterial fraction with an organic solvent; one obtained by directly drying and solidifying a culture supernatant component may be used as a Monascus dye. Examples of an extraction solvent that can be used include n-propyl alcohol, methanol, ethanol, butanol, acetone, ethyl acetate, dioxane, and chloroform. A method involving isolation by each of silica gel chromatography and reversed phase, high performance liquid chromatography as ordinary isolation methods can be employed for purifying an extract, and a Monascus dye having a desired purity can be obtained by purification.

The Monascus dye thus obtained is a mixture of a water-insoluble component and a water-soluble component. The water-insoluble component is any one of monascorubrin, rubropunctatin, ankaflavin, monascin, monascorubramin, and rubropunctamine while the water-soluble component is one obtained as a result of bonding between monascorubrin or rubropunctatin and a water-soluble amino compound during culture.

When the Monascus dye obtained by the above culture is used as a dye to be incorporated into the ink in the present invention, a culture supernatant or an extract of the supernatant is directly applicable as described above. However, one obtained by further adding a water-soluble amino compound to one of the supernatant and the extract is desirable. The addition of a water-soluble amino compound to a culture supernatant or an extract of the supernatant can promote the production of a water-soluble composite in which monascorubrin or rubropunctatin and the water-soluble amino compound are bonded to each other. The method increases the amount of a water-soluble component in the dye, whereby the color-reducing property/decoloring property of the ink in the present invention can be improved.

Examples of a method of increasing the amount of a water-soluble component in a Monascus dye obtained by culture by adding a water-soluble amino compound to the dye include the following method. First, Monascaceae fungi are cultured under acidic conditions. Culture is continued while acetic acid as a pH adjustor is fed so that a reaction between monascorubrin or rubropunctatin and a water-soluble amino compound is suppressed, whereby a dye containing large amounts of monascorubrin and rubropunctatin which are insoluble in water is produced. An excessive amount of a water-soluble amino compound is added to the culture solution, and the pH of the mixture is adjusted to neutrality. After that, the fungus bodies are removed by centrifugal separation or filtration, whereby a dye with an increased amount of a water-soluble component is obtained. The examples further include a method involving: performing culture under acidic conditions; extracting a dye containing monascorubrin or rubropunctatin from the culture solution with an organic solvent; and causing the extract to react with a water-soluble amino compound. The method reduces the content of an impurity except the dye. Moreover, a Monascus dye is obtained as a mixture of limited dyes, and decoloring property is improved in the method of erasing an image of the present invention using the dye. Examples of an extraction solvent that is used for extracting a dye from the culture solution include ethyl acetate, acetone, butanol, ethanol, and methanol. When ethyl acetate is used as an extraction solvent among those, and then water is used as a cleaning fluid for an extract, a decoloring effect in the present invention can be improved.

When one kind or a mixture of two or more kinds selected from the group consisting of an amino acid, a water-soluble protein, a peptide, and a nucleic acid compound is added as a water-soluble amino compound to the Monascus dye obtained by the above culture, an excellent decoloring effect in the present invention can be obtained. When a dye is extracted, and a water-soluble amino compound is added to the dye, any solvent may be used; a 50 mass % aqueous solution of ethanol, a 50 mass % aqueous solution of methanol, or a 50 mass % aqueous solution of acetonitrile is desirably used.

Biolacein as a natural dye to be used in the ink in the present invention is produced by a microorganism belonging to the genus Chrornobacteriurn, Janthinobacterium, or Alteromonas. Biolacein held in the fungus bodies of their variants or mutants can also be exemplified.

In order to obtain such biolacein, it is sufficient to use Janthinobacterium lividum (catalog number JCM 9045 of RIKEN, Japan Collection of Microorganisms). The amount of a violet dye produced by Janthinobacterium lividum significantly varies depending on the kind of a medium. Accordingly, it is desirable to perform culture by using a mannite YE medium or potato semi-synthesized medium that produces a large amount of a violet dye while a temperature and pH are maintained at 5 to 30° C. and 6.0 to 8.0, respectively. A dye can be extracted from the resultant fungus body by solvent extraction. Examples of a solvent that can be used for extracting the dye include n-propyl alcohol, methanol, ethanol, dioxane, and chloroform. An extract can be purified by means of each of silica gel chromatography and reversed phase, high performance liquid chromatography as ordinary isolation methods. As a result of the purification, biolacein having a desired purity can be obtained. The extract can be concentrated and used as it is.

Any extracted dye can be used as a natural dye for use in the ink in the present invention, and specific examples of such extracted dye include the following: dyes extracted from plants such as a turmeric dye, a gardenia dye, carotene, a safflower dye, an annatto dye, a paprika dye, a perilla dye, a grape juice dye, a red radish dye, a red cabbage dye, a purple sweet potato dye, a chlorophyll dye, a cacao dye, and an indigo-based dye, and animal dyes such as a lac dye, a cochineal dye, and a sepia dye.

Of those, a gardenia dye or a paprika dye can be an example of a dye having high decoloring property.

Any synthetic dye can be used in the ink in the present invention, and specific examples of the dye include an anthraquinone-based dye, a triphenylmethane-based dye, a phthalocyanine-based dye, a polyene-based dye, and an indigo-based dye.

(Solvent)

An organic solvent to be used in ink-jet ink can be used as an organic solvent for dissolving or dispersing any one of the above dyes of which the above ink is constituted. Specific examples thereof include an alcohol, a glycol, a glycol ether, a fatty acid ester, a ketone, an ether, a hydrocarbon solvent, and a polar solvent. Of those, examples of a preferable organic solvent for dissolving or dispersing any one of the above dyes include the following.

That is, the examples include alcohols such as methanol, ethanol, 1-propanol, 2-propanol, 1-butanol, 2-butanol, isobutyl alcohol, and t-butyl alcohol, and glycols such as ethylene glycol, diethylene glycol, triethylerie glycol, polyethylene glycol, propylene glycol, dipropylene glycol, polypropylene glycol, butylene glycol, hexanediol, pentanediol, glycerin, hexanetriol, and thiodiglycol.

Any one of those organic solvents may be used alone, or two or more kinds of them may be used in combination. Specific examples of the combination include a combination of an alcohol and a polar solvent, a combination of a glycol and a polar solvent, and a combination of an alcohol, a glycol, and a polar solvent. Examples of the polar solvent include the following.

That is, the examples include 2-pyrrolidone, formamide, N,N-dimethylformamide, N,N-dimethylacetamide, dimethyl sulfoxide, sulforan, N-methyl-2-pyrrolidone, N-vinyl-2-pyrrolidone, 2-oxazolidone, 1,3-dimethyl-2-imidazolidinone, acetonitrile, and acetone.

In addition, in the case of water-soluble organic solvents, mixed solvents obtained by adding water to them can also be used. In such cases, a water content in ink is desirably in the range of 30 to 95 mass % with respect to the total mass of the ink.

An example of a method of dispersing and dissolving any one of the above dyes in any one of those solvents is a method involving merely adding the dye to the solvent to dissolve the dye. As required, the dye may be turned into fine particles by using a dispersion machine, and may be dispersed by using a dispersant (surfactant). Examples of the dispersion machine include the following.

That is, the examples include a ball mill, a sand mill, an attritor, a roll mill, an agitator mill, a Henschel mixer, a colloid mill, an ultrasonic homogenizer, a pearl mill, a jet mill, and an ong mill. The surfactant to be used may be any of cationic, anionic, amphoteric, and nonionic surfactants.

The content of the dye is 0.01 to 90 mass % with respect to the total mass of the ink, and if limited, 0.5 to 15 mass %. Ink having a dye content in such range can form an image suitable for a recording medium.

Ink may further contain, if necessary, a binder, a pH regulating agent, a viscosity regulating agent, a penetrating agent, a surface tension regulating agent, an antioxidant, an antiseptic, or an antimold agent.

(Erasing of Image)

A method of erasing an image of the present invention involves exposing an image formed on a recording medium to plasma generated by dielectric barrier discharge or to an oxidizing gas as a secondary product produced by the plasma to make a dye in ink colorless.

Dielectric barrier discharge to be employed in the present invention is a method involving: coating one side or both sides inside electrodes with a dielectric substance; applying a voltage between the electrodes to generate discharge; and producing the plasma of a gas present between the electrodes. According to the method, plasma can be stably generated in the air. In the present invention, the dielectric barrier discharge is applicable to each of a closed system and an open system. Examples of an electrode material for use in the dielectric barrier discharge include: metals such as Sn, In, Al, Cr, Au, Ni, Ti, W, Te, Mo, Fe, Co, and Pt, and alloys of the metals; oxides such as ITO and ZnO; and a polymer sheet or rubber belt in which conductive particles are dispersed. An electrode shape may be a plate shape, a mesh shape, a belt shape, a drum shape, or a linear shape. Both the electrodes may have different shapes.

Examples of a usable dielectric material with which an electrode is coated include a carbon compound, ceramics, glass, a ferroelectric material, and a polymer discharge material. Specific examples of the dielectric material include the following.

That is, the examples include: diamond, diamond-like carbon, and metal oxides such as silica, magnesia, alumina, and zirconia; nitrides such as silicon nitride and aluminum nitride; magnesium titanate; barium titanate; lead zirconate titanate; polyethylene; vinyl chloride; polyethylene terephthalate; acrylic resin; polycarbonate; and polyvinylidene floride. A dielectric substance can be used by: forming those materials into a sheet and stucking it to an electrode; forming an electrode film under vacuum on a surface of the dielectric substance by an ion plating method; or preparing and applying a complex in which those materials are dispersed in a binder.

Examples of a gas that produces plasma by the dielectric barrier discharge include air, oxygen, nitrogen, carbon dioxide, and water vapor. Specific examples of plasma (ionization/dissociation gas) or a secondary product of the plasma include ozone, a hydroxyl radical, a carbonate ion, and an oxidizing gas of a nitrogen oxide.

The dielectric barrier discharge to be employed in the present invention is preferably discharge involving the application of a voltage between a first electrode coated with a dielectric substance and a second electrode separated from the first electrode. The voltage to be applied between the first electrode and the second electrode is preferably an alternating voltage having a voltage amplitude Vpp of 1 to 40 kV and a frequency of 10 Hz to 20 kHz. Further, the application of an alternating voltage having a voltage amplitude Vpp of 1 to 30 kV and a frequency of 20 Hz to 10 kHz enables an image to be erased with improved efficiency. The wave form of the alternating voltage to be applied may be a sinusoidal wave form, a triangular wave form, a square wave form, or a pulse wave form, or may be a combination of two or more of those wave forms.

Upon exposure of ink fixed on a recording medium to an oxidizing gas generated by the dielectric barrier discharge, the recording medium is preferably placed inside or near a discharge region because an image can be efficiently erased. In this case, it is preferable that: the dielectric substance with which the first electrode is coated and the surface on which the ink is fixed be placed in parallel to be opposed to each other; and a distance between the dielectric substance and the recording medium be larger than 0 and 100 mm or less. The distance is more preferably 0.5 mm or more. In addition, an image can be efficiently erased when an electrode surface coated with the dielectric substance has an area equal to or larger than that of the recording medium.

In the present invention, the recording medium may be exposed to an oxidizing gas generated by the dielectric barrier discharge while the recording medium is left still standing; the exposure can be performed while the recording medium is caused to travel in or near the discharge region. Any known conveying means can be used as means for causing the recording medium to travel. For example, the recording medium can be conveyed by using an endless belt, a roll, or a drum. Such means for conveying the recording medium, which does not need to be conductive, may be conductive to function as the second electrode. The rate at which the recording medium is conveyed can be selected depending on a distance between the recording medium and a dielectric substance, and the magnitude of an applied voltage. The recording medium is conveyed at a rate of preferably 2,000 cm/min or less, or more preferably 600 cm/min or less relative to the first electrode coated with the dielectric substance. The rate within the range enables an image to be erased with improved efficiency and sufficiency. When the recording medium is kept stationary, or conveyed, in a state of being floated between the dielectric substance with which the first electrode is coated and the second electrode, the ink on both surfaces of the recording medium can be made colorless. Whether a printed article is exposed to an oxidizing gas in a closed system or an open system can be selected depending on a purpose. In the present invention, the exposure is preferably performed in a closed system because the oxidizing gas does not leak from an apparatus. It is preferable to provide an adsorption filter for preventing the oxidizing gas from leaking irrespective of whether the exposure is performed in a closed system or an open system.

When a printed article is exposed to an oxidizing gas in a closed system, a dielectric barrier discharge apparatus is preferably provided with a feedback mechanism via which an ozone concentration is kept constant. The ozone concentration can be detected as a result of comparison with a comparative gas in the dielectric barrier discharge apparatus by employing a UV absorption method. In addition, the ozone concentration in the dielectric barrier discharge apparatus is preferably 100 ppm or more for making the printed article colorless. When the ozone concentration is lower than the value, it is preferable to actuate a dielectric barrier discharger immediately to generate an oxidizing gas.

In addition, in the present invention, after the completion of a treatment for making the printed article colorless, it is preferable to increase a voltage value or a frequency to be applied to the dielectric barrier discharge apparatus to heat the discharger so that ozone unnecessary for making the printed article colorless is decomposed. An ambient temperature of 100° C. or higher is preferable for the efficient decomposition of ozone under heat.

(Time Required for Image to be Erased)

An image formed on a recording medium can be subjected to color fading (color reduction) by being exposed to an oxidizing gas, or can be preferably erased by the exposure to such an extent that the image cannot be visually recognized. When the image is exposed to the oxidizing gas, the color of the image becomes pale, and, finally, the image cannot be visually recognized. Although a discharge voltage has a large influence on the erasing of an image, the time required for the image to be erased varies depending on conditions including: the efficiency with which the image is brought into contact with the oxidizing gas; the composition of the oxidizing gas; the kind of a dye; the concentration of the dye; the composition of the dye; and a material for the recording medium. Selecting those conditions can adjust the time required for the image to be erased. When a transparent or semi-transparent material is used as a dielectric substance or an electrode material, and a line sensor or an image sensor is placed on an electrode side to measure an ink concentration on the recording medium, a discharge duration can be changed depending on the ink concentration, whereby the image can be made colorless uniformly at any concentration. Examples of the transparent or semi-transparent material include glass and ITO.

(Image Erasing Apparatus)

An image erasing apparatus of the present invention is an image erasing apparatus for erasing an image formed by applying ink containing a dye to a recording medium, and is characterized by including means for exposing the image to an oxidizing gas generated by dielectric barrier discharge.

The image erasing apparatus of the present invention will be described with reference to the drawings. The case where air is used in the following apparatus will be described.

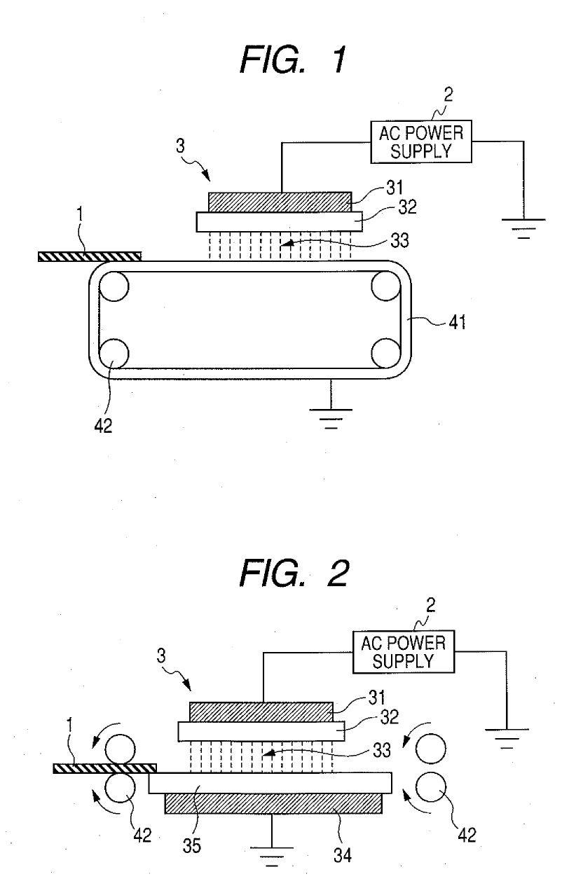

FIG. 1 is a schematic side view showing an example of an image erasing apparatus of the present invention. As shown in FIG. 1, barrier discharge electrodes 3 including a first electrode 31 and a second electrode 41 which are separated by a dielectric substance 32 and which are provided to be opposed to each other are provided. The dielectric substance 32 is provided to be in close contact with the first electrode 31. The second electrode 41 is a conductive endless belt that moves in an endless manner owing to the rotation of rolls 42, and functions as a portion for supporting a recording medium 1 and as means for conveying the medium 1. The first electrode 31 is connected to a reference potential point via an AC power supply 2. When a voltage is applied from the AC power supply 2, an oxidizing gas is generated in a discharge region 33 between the second electrode 41 connected to a reference potential point and the dielectric substance 32. Since the second electrode 41 is of a belt shape, the discharge region 33 is expanded, the oxidizing gas can be generated over a wide range, and the recording medium can be efficiently exposed to the oxidizing gas. A positive or negative direct voltage can be applied to the second electrode 41.

The alternating voltage to be applied to the barrier discharge electrodes 3 preferably has an amplitude Vpp in the range of 1 to 40 kV and a frequency in the range of 10 Hz to 20 kHz. Setting the amplitude and the frequency in those ranges enables the oxidizing gas to be generated with improved efficiency. The amplitude Vpp is more preferably in the range of 1 to 30 kV, and the frequency is more preferably in the range of 20 Hz to 10 kHz. The wave form of the alternating voltage to be applied may be a sinusoidal wave form, a delta wave form, a rectangular wave form, or a pulse wave form, or may be a combination of two or more of those wave forms. In this case, a distance between the dielectric substance 32 and the recording medium 1 is 100 mm or less, and exceeds 0 mm. The first electrode 31, the second electrode 41, and the dielectric substance 32 are made of the above materials.

The recording medium 1 can be exposed to the oxidizing gas while the recording medium is moved with respect to the discharge region 33, or while the rotation of the rolls 42 is stopped so that the recording medium is stationary. The rate at which the recording medium is conveyed can be selected depending on the amplitude Vpp and frequency of the voltage to be applied to the electrodes, and the distance between the dielectric substance and the recording medium. When the amplitude Vpp and frequency of the voltage, and the distance between the dielectric substance and the recording medium are within the above ranges, a rate at which the recording medium is conveyed of 2,000 cm/min or less, or, if additionally limited, of 600 cm/min or less enables an image to be erased with improved efficiency.

Whether the recording medium 1 is exposed to the oxidizing gas in a closed system or an open system can be selected depending on a purpose; provided that, when the exposure is performed in a closed system so that the oxidizing gas does not leak from the apparatus, it is sufficient to provide an adsorption filter for preventing the oxidizing gas from leaking.

FIG. 2 is a schematic side view showing another example of the image erasing apparatus of the present invention. As shown in FIG. 2 (The same members or parts as those of the apparatus shown in FIG. 1 are represented by the same reference numerals as those shown in FIG. 1), the barrier discharge electrodes 3 including the first electrode 31 coated with the dielectric substance 32 and a second electrode 34 coated with a dielectric substance 35 serving also as a portion for supporting the recording medium 1 are provided. An alternating voltage is applied between the first electrode 31 connected to the AC power supply 2 connected to a reference potential point and the second electrode 34 connected to a reference potential point. Then, when the recording medium 1 is conveyed by the rotation of the pair of rolls 42 onto the dielectric substance 35 in the discharge region 33 formed between the dielectric substance 32 and the dielectric substance 35, the recording medium 1 is exposed to plasma generated in the discharge region 33, whereby an image is made colorless. The above materials can be used in the first electrode 32, the second electrode 34, and the dielectric substances 32 and 35.

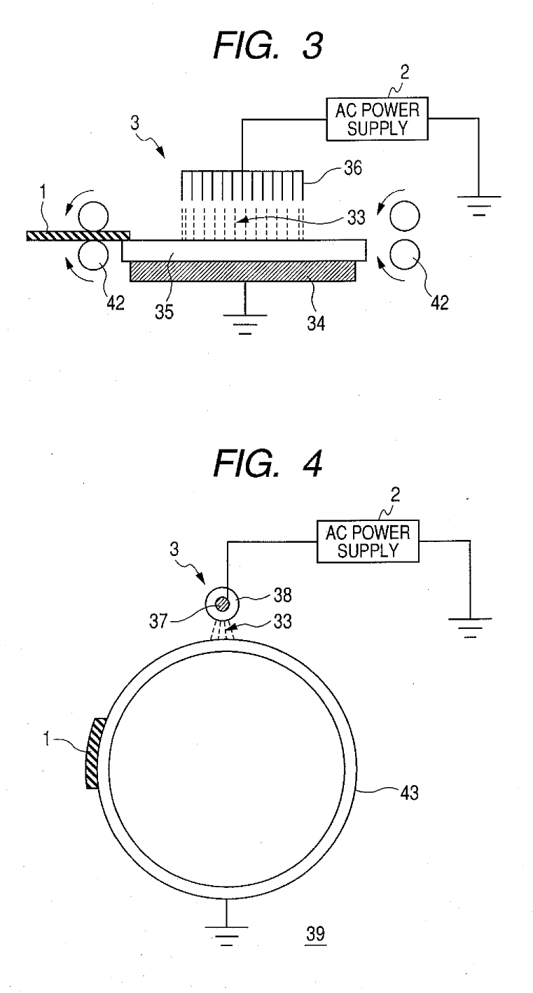

FIG. 3 is a schematic side view showing another example of the image erasing apparatus of the present invention. As shown in FIG. 3 (the same members or parts as those of the apparatus shown in FIG. 2 are represented by the same reference numerals as those shown in FIG. 2), the barrier discharge electrodes 3 including a brush-like, needle-like electrode 36 as a second electrode and the electrode 34 coated with the dielectric substance 35 and serving as a first electrode are provided. The discharge region 33 is formed mainly by the dielectric substance 35 and the vicinities of the tips of the needles of the needle-like electrode 36, and an oxidizing gas is generated in the region.

FIG. 4 is a schematic side view showing another example of the image erasing apparatus of the present invention. As shown in FIG. 4 (the same members or parts as those of the apparatus shown in FIG. 1 are represented by the same reference numerals as those shown in FIG. 1), a rod electrode 37 coated with a roll-like dielectric substance 38 and serving as a first electrode is provided. The barrier discharge electrodes 3 including a conductive drum 43 as a second electrode that functions as a portion for supporting the recording medium 1 and as means for conveying the recording medium 1 are provided. When an alternating voltage is applied between the rod electrode 37 connected to a reference potential point via the AC power supply 2 and the conductive drum 43 connected to a reference potential point, an oxidizing gas is generated in the discharge region 33 between the dielectric substance 38 and the conductive drum 43. Then, the recording medium 1 supported on the surface of the conductive drum 43 is conveyed to the discharge region 33 in association with the rotation of the conductive drum 43, whereby the recording medium 1 is exposed to the oxidizing gas. In this case, a distance between the dielectric substance 38 and the recording medium 1 is 100 mm or less, and exceeds 0 mm. The rod electrode 37, the conductive drum 43, and the dielectric substance 38 are made of the above materials.

(Power Supply for use in Image Erasing Apparatus)

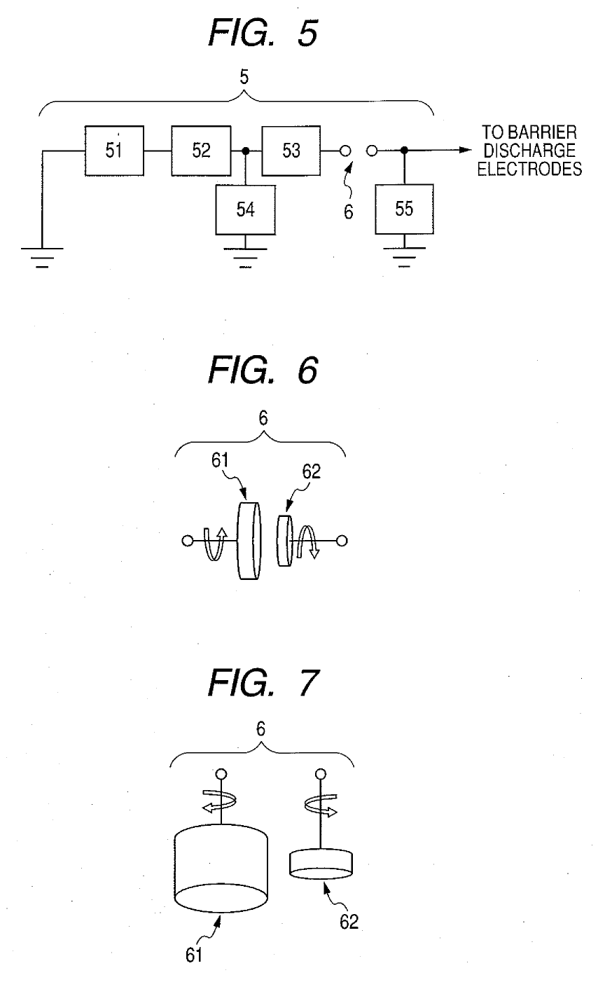

A power supply for use in the image erasing apparatus of the present invention has only to be one capable of outputting an alternating voltage having a voltage amplitude Vpp of 1 to 40 kV and a frequency of 10 Hz to 20 kHz. However, a commercially available AC power supply using a semiconductor involves a problem in that the power supply is expensive. In contrast, a cost for a power supply using an aerial gap can be one tenth or less of a cost for the above-mentioned power supply. FIG. 5 is a schematic view showing an example of the power supply for use in the image erasing apparatus of the present invention. The power supply is of a simple constitution in which a commercially available transformer 51 is used as an input power supply, and electrical elements 52 to 55 and an aerial gap 6 are connected. The electrical elements 52 and 53 are each a resistor or a coil. In addition, the electrical element 54 is a capacitance, and the electrical element 55 is a resistor. On the other hand, the aerial gap 6 is constituted of any one of a combination of needles, a combination of flat plates, a combination of blades, and a combination of cylindrical shapes, and any material can be used in the gap as long as the material has conductivity.

FIGS. 6 and 7 are each a schematic view showing an example of the aerial gap for use in the image erasing apparatus of the present invention. In each of those figures, the aerial gap is composed of two flat plate metal electrodes 61 and 62 having different sizes, and is constituted in such a manner that the respective electrodes rotate in directions opposite to each other so that an influence of deterioration due to aerial discharge is reduced. An alternating voltage having a commercial frequency is applied to the transformer 51, and a distance between the flat plate metal electrodes of the aerial gap 6 is set to an arbitrary value of 10 mm or less, whereby an alternating voltage including a pulse wave form having a voltage amplitude Vpp of 1 to 40 kV and a frequency of 10 Hz to 20 kHz is generated, and hence good barrier discharge is obtained. In addition, the distance of the gap, and the kind and value of each of the electrical elements can be arbitrarily set depending on the shape and size of the barrier discharge electrodes.

(Method of Recycling Recording Medium)

A method of recycling a recording medium of the present invention is not limited as long as the method includes the step of employing the above-mentioned method of erasing an image of the present invention. An oxidizing gas generated by dielectric barrier discharge is used for advancing the cleavage reaction of a dye in an image formed on a recording medium, so the dye on the recording medium can be efficiently, easily, and quickly made colorless.

In the present invention, the following procedure is preferably adopted: before a printed article is exposed to an oxidizing gas, the printed article is held in a water vapor atmosphere having a temperature of 20° C. and a humidity of 50% RH or more, and then dielectric barrier discharge is performed. The reason why such procedure is preferable is as follows: the printed article can be made colorless with improved ease and improved quickness because water vapor facilitates the separation of a dye on the printed article into a monomolecular state.

Moreover, the present invention can prevent a substance that oxidizes the dye from remaining on the recording medium. As a result, even when ink containing a dye is applied again to the recording medium carrying the dye which has been made colorless to form an image, the cleavage reaction of the dye does not proceed, and a colored state can be maintained, so it becomes possible to recycle the recording medium.

### EXAMPLES

Hereinafter, the present invention will be described in more detail by way of the following examples, but the technical scope of the present invention is not limited to those examples.

### Recording Medium Production Example 1

Fine alumina powder (trade name: CATALOID AP-3, manufactured by Shokubai Kasei Kogyo Co.) and polyvinyl alcohol (trade name “SMR-10HH”, manufactured by Shin-Etsu Chemical Co., Ltd.) were mixed at a mass ratio of the fine powder to polyvinyl alcohol of 90/10. Then, water was added to the mixture in such a manner that a solid content ratio would be 20 mass %, and the whole was stirred. The resultant was applied onto a PET film in such a manner that a mass after drying would be 25 g/m², and the whole was dried at 110° C. for 10 minutes, to thereby obtain a recording medium 1.

### Recording Medium Production Example 2

In a 2-liter flask equipped with an agitator, 800 g of polyethylene glycol (having an average molecular weight of 2,000), 65 g of hexamethylene diisocyanate, 2 g of dibutyl tin dilaurate, and 900 g of ethylene glycol dimethyl ether were charged. The whole was stirred for 30 minutes at room temperature to be uniformly mixed, and heated to 80° C. and stirred for 2 hours and then cooled, to thereby obtain a highly viscous transparent liquid (binder A). The obtained liquid showed a viscosity of 30,000 mPa·s at 25° C., and the polymer contained in an ethylene glycol dimethyl ether solvent had a number-average molecular weight of 85,000. Next, a recording medium 2 was obtained in the same manner as in the Production Example 1 except that polyvinyl alcohol was replaced by the binder A obtained by the above operations.

### Recording Medium Production Example 3

In a 2-liter flask equipped with an agitator, 300 g of hydroxyethyl methacrylate, 350 g of water, 350 g of methanol, and 1.5 g of azobisisobutyronitrile were charged, and the whole was stirred for 60 minutes at room temperature. After that, nitrogen gas was blown in the flask to sufficiently replace the interior of the flask, and the temperature was raised to 65° C. while gradually adding a nitrogen gas in the flask. After the mixture was subjected to polymerization for 3 hours in this state, the resultant was cooled to obtain a highly viscous transparent liquid (binder B). The obtained liquid showed a viscosity of 1,800 mPa·s at 25° C., and the polymer contained in a water/methanol mixed solvent had a number-average molecular weight of 150,000. Next, a recording medium 3 was obtained in the same manner as in the Production Example 1 except that polyvinyl alcohol was replaced by the binder B obtained by the above operations.

### Recording Medium Production Example 4

Colloidal silica (trade name: SNOWTEX C, manufactured by Nissan Chemical Co.) and polyvinyl alcohol (trade name “SMR-10HH”, manufactured by Shin-Etsu Chemical Co., Ltd.) were mixed at a mass ratio of the fine powder to polyvinyl alcohol of 90/10. Then, water was added to the mixture in such a manner that a solid content ratio would be 20 mass %, and the whole was stirred. The resultant was applied onto a PET film in such a manner that a mass after drying would be 35 g/m², and the whole was dried at 110° C. for 10 minutes, to thereby obtain a recording medium 4.

### Ink Production Examples 1 to 5

The respective components shown in the following Table 1 were mixed and sufficiently stirred for dissolution. Next, the mixture was filtered through a Floropore Filter (trade name: manufactured by Sumitomo Electric Industries, Ltd.) having a pore size of 0.45 μm under pressure, to thereby obtain inks 1 to 5. Note that the inks were obtained by using copper phthalocyanine tetrasodium tetrasulfonate manufactured by Kishida Kagaku Co, a gardenia yellow dye, a paprika dye, and a chlorophyll each manufactured by Kiriya Chemical Co., Ltd, and a dye as indigo carmine manufactured by Nakarai Tesk Co.

TABLE 1

| | Ink 1 | Ink 2 | Ink 3 | Ink 4 | Ink 5 |
|---|---|---|---|---|---|
| Copper | 2.5 | | | | |
| phthalocyanine | | | | | |
| tetrasodium | | | | | |
| tetrasulfonate | | | | | |
| Gardenia yellow dye | | 2.5 | | | |
| Paprika dye | | | 2.5 | | |
| Chlorophyll | | | | 2.5 | |
| Indigo carmine | | | | | 2.5 |
| Glycerin | 7.5 | 7.5 | 7.5 | 7.5 | 7.5 |
| Diethylene glycol | 7.5 | 7.5 | 7.5 | 7.5 | 7.5 |
| *Acetylenol EH | 0.1 | 0.1 | 0.1 | 0.1 | 0.1 |
| Water | 82.4 | 82.4 | 82.4 | 82.4 | 82.4 |

(Unit: mass %)
*Acetylenol EH (trade name, manufactured by Kawaken Fine Chemical Co.): ethylene oxide adduct of acetylene alcohol (HLB = 14 to 15)

### Ink Production Example 6

In a 500-ml Sakaguchi flask, the following was charged.

That is, charged was 100 ml of a malt yeast extract YE medium (composed of 1 mass % of glucose, 0.3 mass % of yeast extract (manufactured by Difco Laboratories, Inc.), 0.3 mass % of malt extract (manufactured by Difco Laboratories, Inc.), 0.5 mass % of bactopeptone (manufactured by Difco Laboratories, Inc.), and pure water as the balance.

The medium was adjusted to have a pH value of 6.5 and then sterilized under pressure for 20 minutes at 120° C. After being cooled, the medium was inoculated with a loopful of Monascus purpureus (NBRC 4478) obtained by slant culture on a YM agar medium, and cultivated by shaking for 2 days at 30° C. to obtain a seed culture solution. 5 ml of the thus-obtained seed culture solution was inoculated in 100 ml of a YM culture medium, which was sterilized as described above, and the resultant was subjected to main culture by shaking for 3 days at 30° C. After the main culture, the culture was centrifuged (9,000 rpm, 10 min) to separate a supernatant from fungus bodies. The obtained supernatant showed an optical absorbance of 0.2 at a wavelength of 500 nm in 1/100 dilution in distilled water. The supernatant was added with an equal amount of ethanol, and the whole was stirred, and further centrifuged (9,000 rpm, 10 min) to eliminate water-insoluble dyes. The obtained supernatant was concentrated to dry to obtain a water-soluble red dye. The dye was mixed with ethanol at a ratio of dye/ethanol=10.0/90.0, and then the mixture was sufficiently stirred for dissolution and filtered through a Floropore Filter (trade name: manufactured by Sumitomo Electric Industries, Ltd.) having a pore size of 0.45 μm under pressure, to thereby prepare an ink 6.

### Culture Examples 1 to 4

In a 5-liter Sakaguchi flask, 1 liter of a YM culture medium same as in the Ink Production Example 6 was charged. After being adjusted to have a pH value of 6.5, the medium was sterilized under pressure for 20 minutes at 120° C. After being cooled, the medium was inoculated with a loopful of Monascus purpureus (NBRC 4478) obtained by slant culture on a YM agar medium, and cultivated by shaking for 2 days at 30° C. to obtain a seed culture solution.

On the other hand, in a 1-liter glass jar, 450 ml of a YM culture medium same as described above was charged, then sterilized under pressure for 20 minutes at 120° C. After being cooled, the medium was inoculated with the seed culture solution by 10% (v/v). Shaking culture under aeration was conducted for 7 days at 30° C. while pH of the culture was maintained at pH 4.0 from the beginning of the culture by utilizing as a pH regulating agent sulfuric acid in the Culture Example 1, phosphoric acid in the Culture Example 2, or acetic acid in the Culture Example 3. In the Culture Example 4, the medium was adjusted to have a pH value at the beginning of the culture of 6.5, and cultivated without pH control. The production amount of monascorubrin in the culture obtained in the Culture Examples 1 to 4 was measured by HPLC. Conditions of HPLC analysis were taken from a method described in WO 02/088265. Obtained results are shown in Table 2.

TABLE 2

| | | | Production amount |
|---|---|---|---|
| | pH regulating | Controlled | of monascorubrin |
| | agent | pH | (mg/L) |
| Culture Example 1 | Sulfuric acid | 4.0 | 220.5 |
| Culture Example 2 | Phosphoric acid | 4.0 | 259.6 |
| Culture Example 3 | Acetic acid | 4.0 | 953.5 |
| Culture Example 4 | None | None | 7.4 |

As shown in Table 2, the amount of monascorubrin was significantly increased by a culture under an acidic condition, and was further increased by employing acetic acid as a pH regulating agent, in comparison with a mineral acid such as sulfuric acid or phosphoric acid. Rubropunctatin and monascorubrin obtained by such culture method can be employed in an addition reaction with an amino compound, thereby obtaining a water-soluble dye in a more efficient manner.

### Ink Production Example 7

The culture obtained in the Culture Example 3 was centrifuged (9,000 rpm, 10 min) to separate a supernatant and fungus bodies. The obtained dye-containing wet fungus bodies were lyophilized to determine its water content, which was 75.6 mass %.

400 g of the obtained wet fungus bodies was added with 10 liters of ethyl acetate, and the whole was stirred for 1 hour and filtered with a filter paper to separate a filtrate and fungus bodies. The aqueous phase was removed from the filtrate to obtain an ethyl acetate layer. The obtained ethyl acetate extract was rinsed twice by adding an equal amount of water. The ethyl acetate extract after rinsing was dried by concentration to obtain a red-orange dye containing monascorubrin and rubropunctatin.

10.8 g of the obtained red-orange dye was added with acetonitrile to obtain 2095 ml of an acetonitrile solution containing the red-orange dye. An equal amount of aqueous solution of monosodium glutamate (30 mg/ml) was added thereto, and the mixture was reacted for 3 days at room temperature while the mixture was stirred, and was dried by concentration to obtain a water-soluble dye. The obtained dye was mixed such that a ratio of dye/glycerin/diethylene glycol/acetylenol/water was 2.5/7.5/7.5/0.1/82.4 (mass ratio), and the mixture was sufficiently stirred to dissolve the components. After that, the mixture was filtered through a Floropore Filter (trade name: manufactured by Sumitomo Electric Industries, Ltd.) having a pore size of 0.45 μm under pressure, to thereby prepare an ink 7.

After the reaction for forming the water-soluble dye by the addition of monosodium glutamate, monascorubrin and rubropunctatin in the reaction liquid were analyzed by reverse phase HPLC, but monascorubrin and rubropunctatin were not detected. Also on a liquid obtained by diluting the reaction liquid with distilled water to 1/100, an absorbance at 500 nm was measured as 0.68.

### Printed Article Production Examples 1 to 10

The obtained inks 1 to 7 were used to conduct solid printing on the recording media 1 to 4 to obtain printed articles 1 to 10. The image forming apparatus used was an on-demand type ink jet printer (trade name: Wonder BJ F-660, manufactured by Canon Corp.) utilizing a heat generating element as an ink ejecting energy source. The contents of the printed articles are shown in Table 3.

TABLE 3

| | Substrate | Ink |
|---|---|---|
| Printed article 1 | 1 | 1 |
| Printed article 2 | 2 | 1 |
| Printed article 3 | 3 | 1 |
| Printed article 4 | 4 | 1 |
| Printed article 5 | 1 | 2 |
| Printed article 6 | 1 | 3 |
| Printed article 7 | 1 | 4 |
| Printed article 8 | 1 | 5 |
| Printed article 9 | 1 | 6 |
| Printed article 10 | 1 | 7 |

(Evaluation for Decoloring Property/Color-reducing Property)

### Examples 1 to 10

A decoloring treatment was performed in a closed system by using the apparatus shown in FIG. 1. The apparatus shown in FIG. 5 was used as an AC power supply, and the constitution shown in FIG. 6 was adopted for an aerial gap. An element having a resistance of 500 kΩ and an element having a capacitance of 2,000 pF were used for the electrical elements 52 and 54, respectively (the electrical elements 53 and 55 were absent). A distance between the metal electrodes of the aerial gap 6 was set to 1.7 mm, an alternating voltage (40 V, 50 Hz) was applied to a neon-sign transformer (AIDEN SHOJI CO., LTD., model 61-2314), and an alternating voltage including a pulse wave form having a frequency of 50 Hz and a voltage amplitude Vpp of 20 kV was applied to the discharge electrodes. It should be noted that the dielectric substance 32 was made of a soda glass measuring 225 mm long by 50 mm wide by 1 mm thick, the electrode 31 provided on the dielectric substance 32 was made of nickel, and the counter electrode (conductive endless belt 41) was made of a carbon-containing ethylene propylene rubber. In that state, each of Printed Articles 1 to 10 was conveyed at a speed of 200 cm/min and subjected to a discharge treatment (Examples 1 to 10). The barrier discharge electrodes 3 and the conductive endless belt 41 were arranged in such a manner that a distance between the bottom face of the dielectric substance and a printed article would be 1.8 mm. In addition, an ozone concentration between the bottom face of the dielectric substance and each of the printed articles (discharge region) measured with an ozone concentration meter (manufactured by DIREC Inc., Model 1300) was about 200 ppm.

The optical densities of each of Printed Articles 1 to 10 before and after the discharge treatment were measured with a color transmission/reflection densitometer (trade name “X-Rite 310TR”, manufactured by X-Rite, Inc.). A ratio of the optical density after the discharge treatment to the optical density before the discharge treatment was calculated as a residual optical density rate from the following expression:

Residual optical density rate=(optical density after discharge treatment/optical density before discharge treatment)×100.

Table 4 shows the results.

### Example 11

Printed Article 10 was subjected to a discharge treatment by using the same apparatus as that of Example 1 in the same manner as in Example 1 except that the frequency and voltage amplitude Vpp of an alternating voltage (sinusoidal wave) to be applied to the discharge electrodes were changed to 5 kHz and 15 kV, respectively. Then, the residual optical density rate of the printed article was calculated in the same manner as in Example 1. Table 4 shows the result. It should be noted that an ozone concentration between the bottom face of the dielectric substance and the printed article (discharge region) measured with an ozone concentration meter (manufactured by DIREC Inc., Model 1300) was about 240 ppm.

### Examples 12 to 21

A square-wave voltage having a frequency of 400 Hz and a voltage amplitude Vpp of 35 kV was applied to the discharge electrodes in an open system by using the apparatus shown in FIG. 4. It should be noted that the roll-like dielectric substance 38 was made of an alumina ceramic having an outer diameter of 30 mm and a thickness of 1 mm, the electrode 37 embedded in the dielectric substance was made of tungsten, and the counter electrode (conductive drum 43 having an outer diameter of 200 mm) was made of a carbon-containing silicone rubber. In that state, each of Printed Articles 1 to 10 was conveyed at a speed of 150 cm/min and subjected to a discharge treatment, and then the residual optical density rate of each of the printed articles was calculated in the same manner as in Example 1 (Examples 12 to 21). The barrier discharge electrodes 3 and the conductive roller 43 were arranged in such a manner that a distance between the bottom face of the dielectric substance and a printed article would be 1.0 mm. Table 5 shows the results. It should be noted that an ozone concentration between the bottom face of the dielectric substance and each of the printed articles (discharge region) measured with an ozone concentration meter (manufactured by DIREC Inc., Model 1300) was about 180 ppm.

TABLE 4

| | | | Residual |
|---|---|---|---|
| | | | optical |
| | Recording | | density rate |
| | medium | Dye in ink | (%) |
| Example | Alumina coated | Copper | 75 |
| 1 | paper | phthalocyanine | |
| | | tetrasodium | |
| | | tetrasulfonate | |
| Example | Alumina coated | Copper | 53 |
| 2 | paper | phthalocyanine | |
| | | tetrasodium | |
| | | tetrasulfonate | |
| Example | Alumina coated | Copper | 55 |
| 3 | paper | phthalocyanine | |
| | | tetrasodium | |
| | | tetrasulfonate | |
| Example | Silica coated | Copper | 43 |
| 4 | paper | phthalocyanine | |
| | | tetrasodium | |
| | | tetrasulfonate | |
| Example | Alumina coated | Gardenia yellow | 5 |
| 5 | paper | dye | |
| Example | Alumina coated | Paprika dye | 9 |
| 6 | paper | | |
| Example | Alumina coated | Chlorophyll | 38 |
| 7 | paper | | |
| Example | Alumina coated | Indigo carmine | 7 |
| 8 | paper | | |
| Example | Alumina coated | Monascus dye | 5 |
| 9 | paper | | |
| Example | Alumina coated | Monascus dye | 6 |
| 10 | paper | | |
| Example | Alumina coated | Monascus dye | 4 |
| 11 | paper | | |

TABLE 5

| | | | Residual |
|---|---|---|---|
| | | | optical |
| | Recording | | density rate |
| | medium | Dye in ink | (%) |
| Example 12 | Alumina coated | Copper | 77 |
| | paper | phthalocyanine | |
| | | tetrasodium | |
| | | tetrasulfonate | |
| Example 13 | Alumina coated | Copper | 57 |
| | paper | phthalocyanine | |
| | | tetrasodium | |
| | | tetrasulfonate | |
| Example 14 | Alumina coated | Copper | 60 |
| | paper | phthalocyanine | |
| | | tetrasodium | |
| | | tetrasulfonate | |
| Example 15 | Silica coated | Copper | 46 |
| | paper | phthalocyanine | |
| | | tetrasodium | |
| | | tetrasulfonate | |
| Example 16 | Alumina coated | Gardenia yellow | 6 |
| | paper | dye | |
| Example 17 | Alumina coated | Paprika dye | 12 |
| | paper | | |
| Example 18 | Alumina coated | Chlorophyll | 42 |
| | paper | | |
| Example 19 | Alumina coated | Indigo carmine | 8 |
| | paper | | |
| Example 20 | Alumina coated | Monascus dye | 6 |
| | paper | | |
| Example 21 | Alumina coated | Monascus dye | 7 |
| | paper | | |
| Comparative | Plain paper | Monascus dye | 99 |
| Example 1 | | | |
| Comparative | Plain paper | Monascus dye | 20 |
| Example 2 | | | |

As is apparent from the above results, in the Examples 1 to 21, printed articles formed with ink jet ink on members applied with inorganic pigments are exposed to an oxidizing gas generated due to dielectric barrier discharge, so the printed articles each show low residual optical density rate and excellent decoloring property/color-reducing property. It is found that the decoloring property/color-reducing property is excellent in the case of employing a natural dye as the dye and particularly more excellent in the case of employing a Monascus dye, a gardenia yellow dye, a paprika dye, or an indigo-based dye. It is also indicated that the decoloring property/color-reducing property is excellent in the case of employing alumina as the inorganic pigment of the member applied with the inorganic pigment.

### Recording Medium Production Examples 5 to 8

Any one of various colloidal silica fine powders and polyvinyl alcohol (trade name “SMR-10HH”, manufactured by Shin-Etsu Chemical Co., Ltd.) were mixed at a mass ratio of the fine powder to polyvinyl alcohol of 90/10. Then, water was added to the mixture in such a manner that a solid content ratio would be 20%, and the whole was stirred. The resultant was applied onto A4 plain paper in such a manner that a mass after drying would be 25 g/m², and the whole was dried at 110° C. for 10 minutes, whereby each of Recording Media 5 to 8 was produced. The pore volume and dispersed particle size of each of the inorganic pigment particles of each of the resultant recording media were measured by the above methods. Table 6 shows the results.

TABLE 6

| | Pore volume of silica | Dispersed particle size |
|---|---|---|
| | particle (cc/g) | of silica particle (μm) |
| Recording medium 5 | 0.1 | 0.9 |
| Recording medium 6 | 0.3 | 0.5 |
| Recording medium 7 | 0.5 | 0.2 |
| Recording medium 8 | 0.6 | 0.1 |

### Recording Medium Production Examples 9 to 13

Any one of various alumina fine powders and polyvinyl alcohol (trade name “SMR-10HH”, manufactured by Shin-Etsu Chemical Co., Ltd.) were mixed at a mass ratio of the fine powder to polyvinyl alcohol of 90/10. Then, water was added to the mixture in such a manner that a solid content ratio would be 20%, and the whole was stirred. The resultant was applied onto A4 plain paper in such a manner that a mass after drying would be 25 g/m², and the whole was dried at 110° C. for 10 minutes, whereby each of Recording Media 9 to 13 was produced. The pore volume and dispersed particle size of each of the inorganic pigment particles of each of the resultant recording media were measured by the above methods. Table 7 shows the results.

TABLE 7

| | | Dispersed particle |
|---|---|---|
| | Pore volume of alumina | size of alumina |
| | particle (cc/g) | particle(μm) |
| Recording medium 9 | 0.2 | 0.7 |
| Recording medium 10 | 0.4 | 0.5 |
| Recording medium 11 | 0.6 | 0.15 |
| Recording medium 12 | 0.7 | 0.1 |
| Recording medium 13 | 0.9 | 0.07 |

### Ink Production Examples 8 to 10

The respective components shown in Table 8 were mixed and sufficiently stirred for dissolution. After that, the solution was filtered through a Floropore Filter (trade name: manufactured by Sumitomo Electric Industries, Ltd.) having a pore size of 0.45 μm under pressure, whereby ink was prepared and obtained. It should be noted that ones manufactured by Kiriya Chemical Co. Ltd. were used as a gardenia blue dye and a paprika dye, and one manufactured by Kishida Chemical Co., Ltd. was used as copper phthalocyanine tetrasodium tetrasulfonate.

TABLE 8

| | Ink 8 | Ink 9 | Ink 10 |
|---|---|---|---|
| Gardenia blue dye | 2.5 | — | — |
| Paprika dye | — | 2.5 | — |
| Copper phthalocyanine | — | — | 2.5 |
| tetrasodium tetrasulfonate | | | |
| Glycerin | 7.5 | 7.5 | 7.5 |
| Diethylene glycol | 7.5 | 7.5 | 7.5 |
| *Acetylenol EH | 0.1 | 0.1 | 0.1 |
| Water | 82.4 | 82.4 | 82.4 |

### Printed Article Production Examples 13 to 24

Solid printing was performed on Recording Media 5 to 8 by using Inks 8 to 10 obtained in the foregoing in the same manner as in each of Printed Article Production Examples 1 to 10, whereby Printed Articles 13 to 24 were produced. The ionization potential of a dye in a solid state before printing and the ionization potential of the dye in a printed article were measured by using an aerial photoelectron spectrometer (manufactured by RIKEN KEIKI Co., Ltd., AC-1). The intensity of light to be applied upon measurement was 10 nW (energy of 5.9 eV) or more. Table 9 shows the results.

### Printed Article Production Examples 25 to 34

Solid printing was performed on Recording Media 9 to 13 by using Ink 5 or 6 obtained in the foregoing in the same manner as in each of Production Examples 1 to 10, whereby Printed Articles 25 to 34 were produced. Then, the ionization potential of each printed article was measured. Table 10 shows the results.

(Evaluation for Color-reducing Property/decoloring Property)

### Examples 22 to 33

An alternating voltage (triangular wave) having a frequency of 1 kHz and a voltage amplitude Vpp of 25 kV was applied to the discharge electrodes in a closed system by using the apparatus shown in FIG. 3. It should be noted that the needle-like electrode 36 was made of tungsten, the dielectric substance 35 was made of a soda glass measuring 250 mm wide by 300 mm long by 0.5 mm thick, and the counter electrode 34 provided for the bottom face of the dielectric substance 35 was made of an aluminum plate. In that state, each of Printed Articles 13 to 24 was conveyed at a speed of 180 cm/min and subjected to a discharge treatment (Examples 22 to 33). Arrangement was performed in such a manner that a distance between the discharge needle-like electrode 36 and a printed article would be 1.2 mm.

After that, the residual optical density rate of each of the printed articles was calculated in the same manner as in Example 1. Table 9 shows the results. It should be noted that an ozone concentration between the discharge needle-like electrode and each of the printed articles (discharge region) measured with an ozone concentration meter (manufactured by DIREC Inc., Model 1300) was about 190 ppm.

### Examples 34 to 43

A decoloring treatment was performed in an open system by using the apparatus shown in FIG. 2 in a state where each of Printed Articles 25 to 34 was kept stationary directly below the barrier discharge electrodes by using the conveying rolls 42. The apparatus shown in FIG. 5 was used as an AC power supply, and the constitution shown in FIG. 7 was adopted for an aerial gap. An element having an inductance of 0.9 mH, an element having a resistance of 10 kΩ, an element having a capacitance of 1,000 pF, and an element having a resistance of 10 kΩ were used for the electrical elements 52, 53, 54, and 55, respectively. A distance between the metal electrodes of the aerial gap 6 was set to 2 mm, an alternating voltage (80 V, 50 Hz) was applied to an inverter neon-sign transformer (LECIP CORPORATION, M-5), and an alternating voltage including a pulse wave form having a frequency of 50 Hz and a voltage amplitude Vpp of 30 kV was applied to the discharge electrodes for 10 seconds, whereby a discharge treatment was performed (Examples 34 to 43). It should be noted that the dielectric substance 32 was made of a magnesia single crystal measuring 250 mm wide by 300 mm long by 0.5 mm thick, the electrode 31 provided on the dielectric substance 32 was made of chromium, the counter dielectric substance 35 was made of a soda glass measuring 250 mm wide by 300 mm long by 0.2 mm thick, and the counter electrode 34 provided for the bottom face of the counter dielectric substance 35 was made of a stainless steel plate. Arrangement was performed in such a manner that a distance between the bottom face of the dielectric substance 32 and a printed article would be 2.0 mm.

After that, the residual optical density rate of each of the printed articles was calculated in the same manner as in Example 1. Table 10 shows the results. It should be noted that an ozone concentration between the bottom face of the dielectric substance and each of the printed articles (discharge region) measured with an ozone concentration meter (manufactured by DIREC Inc., Model 1300) was about 280 ppm.

TABLE 9

| | | | Ioniza- | Ioniza- | |
|---|---|---|---|---|---|
| | | | tion | tion | |
| | | | poten- | poten- | |
| | | | tial of | tial | Residual |
| | | | dye | of | optical |
| | Recording | | powder | image | density |
| | medium | Dye in ink | (eV) | (eV) | rate (%) |
| Example | Recording | Gardenia blue | 5.3 | 5.2 | 17 |
| 22 | medium 5 | dye | | | |
| Example | Recording | Gardenia blue | 5.3 | 5.15 | 15 |
| 23 | medium 6 | dye | | | |
| Example | Recording | Gardenia blue | 5.3 | 5.09 | 11 |
| 24 | medium 7 | dye | | | |
| Example | Recording | Gardenia blue | 5.3 | 5.02 | 8 |
| 25 | medium 8 | dye | | | |
| Example | Recording | Paprika dye | 5.95 | 5.85 | 12 |
| 26 | medium 5 | | | | |
| Example | Recording | Paprika dye | 5.95 | 5.77 | 10 |
| 27 | medium 6 | | | | |
| Example | Recording | Paprika dye | 5.95 | 5.69 | 8 |
| 28 | medium 7 | | | | |
| Example | Recording | Paprika dye | 5.95 | 5.63 | 6 |
| 29 | medium 8 | | | | |
| Example | Recording | Copper | 6.05 | 6.01 | 72 |
| 30 | medium 5 | phthalocyanine | | | |
| | | tetrasodium | | | |
| | | tetrasulfonate | | | |
| Example | Recording | Copper | 6.05 | 5.98 | 61 |
| 31 | medium 6 | phthalocyanine | | | |
| | | tetrasodium | | | |
| | | tetrasulfonate | | | |
| Example | Recording | Copper | 6.05 | 5.95 | 54 |
| 32 | medium 7 | phthalocyanine | | | |
| | | tetrasodium | | | |
| | | tetrasulfonate | | | |
| Example | Recording | Copper | 6.05 | 5.93 | 50 |
| 33 | medium 8 | phthalocyanine | | | |
| | | tetrasodium | | | |
| | | tetrasulfonate | | | |

TABLE 10

| | | | Ionization | | |
|---|---|---|---|---|---|
| | | | potential | Ionization | Residual |
| | | | of dye | potential | optical |
| | Recording | | powder | of image | density |
| | medium | Dye in ink | (eV) | (eV) | rate (%) |
| Example | Recording | Monascus | 5.45 | 5.34 | 13 |
| 34 | medium 9 | dye | | | |
| Example | Recording | Monascus | 5.45 | 5.3 | 10 |
| 35 | medium 10 | dye | | | |
| Example | Recording | Monascus | 5.45 | 5.27 | 7 |
| 36 | medium 11 | dye | | | |
| Example | Recording | Monascus | 5.45 | 5.23 | 5 |
| 37 | medium 12 | dye | | | |
| Example | Recording | Monascus | 5.45 | 5.2 | 4 |
| 38 | medium 13 | dye | | | |
| Example | Recording | Indigo | 5.85 | 5.7 | 19 |
| 39 | medium 9 | carmine | | | |
| Example | Recording | Indigo | 5.85 | 5.55 | 12 |
| 40 | medium 10 | carmine | | | |
| Example | Recording | Indigo | 5.85 | 5.49 | 9 |
| 41 | medium 11 | carmine | | | |
| Example | Recording | Indigo | 5.85 | 5.37 | 7 |
| 42 | medium 12 | carmine | | | |
| Example | Recording | Indigo | 5.85 | 5.32 | 6 |
| 43 | medium 13 | carmine | | | |

As is apparent from the above results, when a dye in a solid state (dye powder) has an ionization potential of 6.0 eV or less and the ionization potential of the dye in an image is lower than that of the dye in a solid state before the preparation of ink by 0.1 eV or more, excellent decoloring property/color-reducing property can be provided for the ink. It is found that, when a Monascus dye, a paprika dye, or an indigo carmine dye is used as a dye, excellent decoloring property/color-reducing property can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-287523, filed Sep. 30, 2005 which is hereby incorporated by reference herein in its entirety.

What is claimed is:

1. A method of erasing an image for erasing an image formed by applying ink containing a dye to a recording medium, comprising exposing the image to an oxidizing gas generated by dielectric barrier discharge.

2. A method of erasing an image according to claim 1, wherein the dielectric barrier discharge comprises discharge involving applying a voltage between a first electrode coated with a dielectric substance and a second electrode separated from the first electrode.

3. A method of erasing an image according to claim 2, wherein the voltage applied between the first electrode and the second electrode comprises an alternating voltage having a voltage amplitude Vpp of 1 to 40 kV and a frequency of 10 Hz to 20 kHz, and a distance between the dielectric substance with which the first electrode is coated and a surface of the recording medium to which the ink is applied is larger than 0 mm and is 100 mm or less.

4. A method of erasing an image according to claim 1, wherein the recording medium has a porous inorganic pigment in its surface.

5. A method of erasing an image according to claim 1, wherein the dye has a polyene structure.

6. A method of erasing an image according to claim 1, wherein the image formed on the recording medium is formed by an ink-jet recording method.

7. An image erasing apparatus for erasing an image formed by applying ink containing a dye to a recording medium, comprising:
means for exposing the image to an oxidizing gas generated by dielectric barrier discharge; and
supporting means for placing the recording medium so that the recording medium is exposable to the oxidizing gas.

8. A method of recycling a recording medium, comprising the step of erasing an image by the method of erasing an image according to claim 1.
